(19) United States
(12) Patent Application Publication
(10) Pub. No.: US 2008/0092203 A1
(43) Pub. Date: Apr. 17, 2008

(54) Approach for channel switch time reduction in IPDC over DVB-H

(75) Inventors: Imed Bouazizi, Tampere (FI); Miska Hannuksela, Ruutana (FI)

Correspondence Address: BANNER & WITCOFF, LTD., 1100 13th STREET, N.W., SUITE 1200, WASHINGTON, DC, 20005-4051, US

(73) Assignee: Nokia Corporation, ESPOO (FI)

(21) Appl. No.: 11/549,460

(22) Filed: Oct. 13, 2006

(51) Int. Cl. H04N 7/16; H04N 7/173

(52) U.S. Cl. 725/135; 725/132; 725/134; 725/142; 725/62

(57) ABSTRACT

Provided are apparatuses and methods for reducing channel switching time in a network environment. The user of a mobile terminal may receive a data stream containing numerous television programs or services. Each of the programs or services may have a Packet Identification (PID) and/or IP address. The invention reduces channel switching time by predicting channel changing behavior. Various procedures are presented in which data is received and cached. The cached data may then be used to reduce the channel switching time during synchronizing and decoding of the new channel.

### TECHNICAL FIELD

Aspects of the invention relate generally to communications networks. More specifically, aspects of the invention relate to reducing channel switching time in communication networks.

### BACKGROUND

Digital broadband broadcast networks enable end users to receive digital content including video, audio, data, and so forth. End users may receive program or service information such as a broadcast program in a data stream via an IP Datacast (IPDC) over a broadcast network, for example. In addition, IP Datacast also defines an Electronic Service Guide (ESG) which is used to provide information to the user

In IP Datacast, two different types of services for content delivery are specified: streaming and file delivery. The streaming service is based on RTP/RTCP as the streaming protocol. The file delivery service is based on FLUTE as the file delivery protocol.

A DVB-H network may carry multiple transport streams. Each transport stream carries a multiplex of DVB services. A multiplex may be defined by the ID of the network of origin and the carrying transport stream ID. A DVB service is composed of components, each of which is transported in an Elementary Stream (ES). A service component is identified by the service ID and a PID or alternatively by the sources and destination IP addresses of the corresponding IP streams.

One of the major design decisions of DVB-H is the use of time slicing. As IPDC services are intended for mobile consumption, they usually are low-bitrate services. A typical stream encoded using H.264/AVC will usually have a bitrate of 128 kbps or 384 kbps. A DVB-H transmission system may provide a bandwidth of 5 or 10 Mbps, which is much higher than the bandwidth of a service. Time slicing is used to reduce power consumption of the receiver by sending bursts of the service at a high bitrate corresponding to the multiplex bitrate (or part of it) and allowing the terminal to turn “off” the receiver for the period of time between two consecutive bursts of the service being received. The transmitter indicates to the receiver the relative starting time of the next burst in every MPE section, so that with the correct reception of at least one section per burst, the receiver is able to correctly synchronize to the elementary stream.

A quality of service parameter measured and used in TV broadcast services includes channel switching time. Long channel switching times are very disturbing to the viewer and may make the service unacceptable. In the design of DVB-H, channel switching time has been traded off to the benefit of high power efficiency, which is achieved through the use of time slicing. When time slicing is used, the data of each service is collected into data bursts and each burst is sent separately. A relatively long off period separates every two consecutive data bursts of a given service. During this “off” period, data of other services is broadcast over the air using the same transport stream. Though the use of time slicing improves power efficiency, the long channel switching times is frustrating to users.

Hence, there is a need for efficient and effective methods and systems for reducing the switching time of channels for use by a mobile terminal in a communication network.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In an aspect of the invention, a method and apparatus is provided for efficient and timely switching between multiple channels and or services within a transport stream. For example, a mobile terminal may switch between channels or services without a lengthy period between channel switching.

In an aspect of the invention, a user's channel switching behavior is predicted and data caching may be utilized to reduce channel switching time for programs or services delivered in a transport stream. The cached content may be used during synchronizing and decoding of the new channel or service.

In another aspect of the invention, different channel switching procedures may be initiated by users. In each of the channel switching procedures, a background download mechanism may be defined to accomplish the channel switching procedure with a minimal amount of channel switching time. The background download may consist of downloading entire data bursts or portions of data bursts for a service or channel in anticipation of the user switching to the predicted service or channel.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a wireless communication system in which one or more illustrative embodiments of the invention may be implemented.

FIG. 2 illustrates an example of a mobile device in accordance with an aspect of the invention.

FIG. 3 illustrates an example of a mapping table for mapping channels or service types with corresponding PID values and IP addresses in accordance with at least one aspect of the invention.

FIG. 4 illustrates an exemplary transport stream in accordance with at least one aspect of the invention.

FIG. 5 illustrates an exemplary procedure for reducing channel switching time during a channel switch procedure using user interface navigation buttons for navigating an ordered list in accordance with at least one aspect of the invention.

FIG. 6 illustrates another exemplary procedure for reducing channel switching time during a channel switch procedure using an electronic service guide in accordance with at least one aspect of the invention.

FIG. 7 illustrates an additional exemplary procedure for reducing channel switching time during a channel switch procedure including a user interface for notifying a user about a service or scheduled event in accordance with at least one aspect of the invention.

FIG. 8 illustrates a partial block diagram illustrating an exemplary receiver in accordance with at least one aspect of the invention.

FIG. 9 illustrates a flow diagram using a service or channel switching procedure in accordance with an aspect of the invention.

FIG. 10 illustrates a flow diagram using an alternative service or channel switching procedure in accordance with at least one aspect of the invention.

FIG. 11 illustrates a flow diagram using a further service or channel switching procedure in accordance with at least one aspect of the invention.

FIG. 12 illustrates a flow diagram for an additional service or channel switching procedure in accordance with at least one aspect of the invention.

FIG. 13 illustrates an alternative embodiment of the flow diagram of FIG. 10 in accordance with at least one aspect of the invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

It is noted that various connections are set forth between elements in the following description. It is noted that these connections in general and, unless specified otherwise, may be direct or indirect and that this specification is not intended to be limiting in this respect.

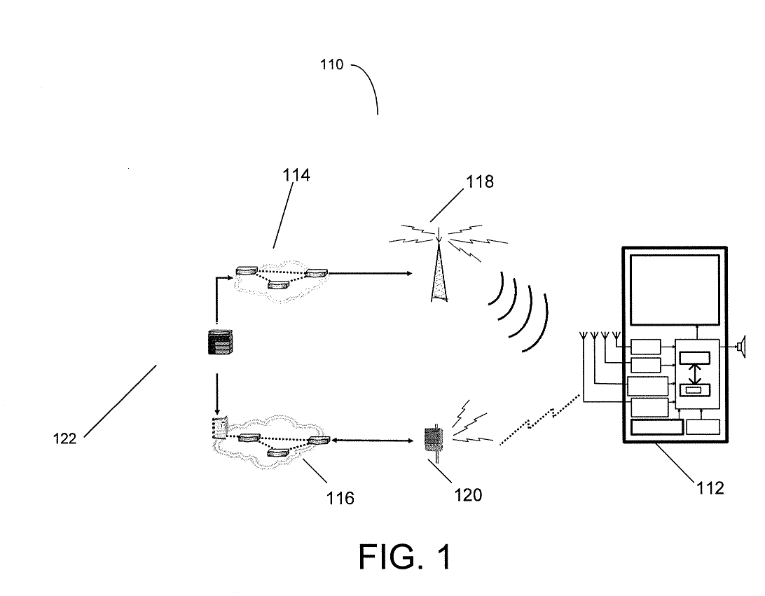

FIG. 1 illustrates an example of a wireless communication system 110 in which the systems and methods of the present invention may be advantageously employed. One or more network-enabled mobile devices 112, such as a personal digital assistant (PDA), cellular telephone, mobile terminal, personal video recorder, portable or fixed television, personal computer, digital camera, digital camcorder, portable audio device, portable or fixed analog or digital radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, analog and/or digital AM/FM radio service providers, SMS/MMS push service providers, Internet content or access providers.

The broadcast network 114 may include a radio transmission of IP datacasting over DVB and/or DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content, which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may include a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, mobile device 112 may include a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

Examples of other digital broadcast standards which digital broadband broadcast system 110 may utilize include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

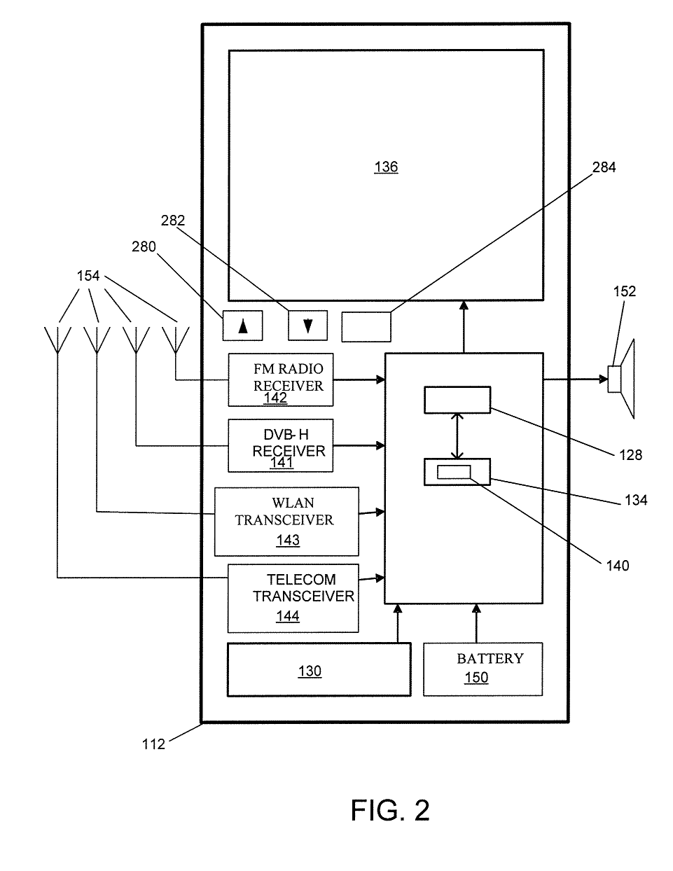

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include at least one input device (not shown) such as keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H or DVB-MIP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbps transmission may have 200, 50 kbps audio program channels or fifty, 200 kbps video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. As discussed above time-slicing may reduce the average power consumption of a mobile terminal and may enable smooth and seamless handover. Time-slicing entails sending data in bursts using a higher instantaneous bitrate as compared to the bitrate required if the data were transmitted using a traditional streaming mechanism. In this case, the mobile device 112 may have one or more buffer memories for storing the decoded time sliced transmission before presentation.

In addition, an Electronic Service Guide (ESG) may be used to provide program or service related information. Generally, an Electronic Service Guide (ESG) enables a terminal to communicate what services are available to end users and how the services may be accessed. The ESG includes independently existing pieces of ESG fragments. Traditionally, ESG fragments include XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One example used in digital video broadcasting (DVB) streams is an electronic program guide (EPG). One type of DVB is Digital video broadcasting-handheld (DVB-H). The DVB-H is designed to deliver 10 Mbps of data to a battery-powered terminal device.

A DVB-H network may carry IP flows of one or more IP platforms and an IP flow can be carried in different IP streams. An IP stream is identified by the original network ID, the transport stream ID, the service ID, the component tag, IP source address, and IP destination address. An IP Stream is encoded using the Multi-protocol Encapsulation (MPE) before transmission over the DVB-H network. MPE-FEC is applied on each source data burst to produce repair data that is used for protection against transport errors. IP packets as well as the MPE-FEC repair data are mapped into MPE sections. MPE sections are then fragmented into TS packets and broadcast over the air.

Along with the DVB services, the DVB-H network may also carry PSI/SI information that provides the receivers with the necessary mapping information and additional information to configure and locate the IP streams of a given service. Several tables are defined by the PSI/SI, the most relevant ones of which are listed in the following.
Program Association Table (PAT): provides the mapping between a given service and the PID value of the corresponding TS packets.
Program Map Table (PMT): provides the mapping between the service and its components.
Network Information Table (NIT): provides information about multiplexes and transport streams within a given DVB-H network.
Time and Date Table (TDT): provides the current network UTC time and date. This table is transmitted at least once every 30 seconds.
IP/MAC Notification Table (INT): provides information about all available IP streams and their mappings to MAC addresses to allow for efficient stream locating and filtering.
Event Information Table (EIT): contains information about current and future events related to each DVB service in the transport stream.

DVB transport streams deliver compressed audio and video data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

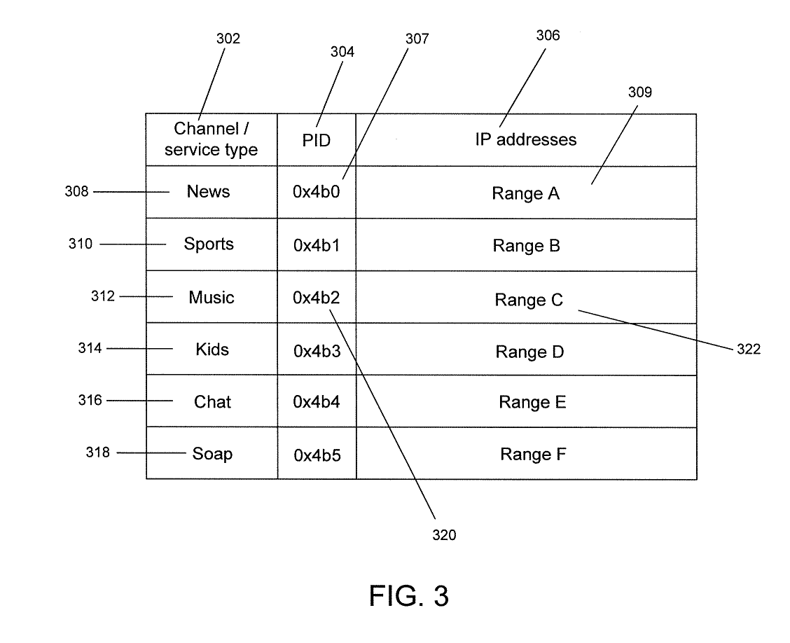

FIG. 3 illustrates an example of a mapping table for mapping channels or service types 302 with corresponding PID values 304 and IP addresses 306 in accordance with at least one aspect of the invention. In an embodiment, a service type 302 may be news 308 which may include news-related programs or services provided to a user. The news-related services may be provided with a particular PID and IP address. In this example, the PID is 0x4b0 307 and the IP addresses 306 are within Range A 309 for the news-related services. FIG. 3 further illustrates multiple service types in addition to news-related services. These examples include sports 310, music 312, kids-related services 314, chat 316 and soap services 318. Each service type has a corresponding PID 304 and IP address range 306. In this example, for any given service type, the same PID and IP addresses may be used to provide the desired type of service (i.e., the PID and/or IP addresses may be “fixed”). For example, if a user desires music services 312 on a mobile terminal at a new location, the mobile terminal may access music services 312 via the fixed PID 320 and IP address range 322 as mapped in the table.

When the user decides to switch to a different channel or service, the terminal may first locate the corresponding service based on Program Specific/Service Specific (PSI/SI) information. The PSI/SI may not be time-sliced and may always be available to the receiver. The terminal then tunes in to the frequency of the requested transport stream, if it is different from the frequency of the current transport stream. Next, the terminal may synchronize with the elementary stream carrying the service. The terminal may have to wait for the arrival of the next burst of the service of interest. Once the terminal has synchronized to the required elementary stream, then the terminal may buffer received data and start decoding from the next available random access point.

Each of the above mentioned steps incurs delays which are of a constant or variable duration. Tuning the receiver to a given frequency usually takes a constant delay. Receiving the PSI/SI information and parsing the information related to a given service may be seen to incur a variable bounded delay, as the PSI/SI must be carouselled at a 30 seconds cycle. This value should be minimal to allow for fast tune-in to a new service. After locating a service, an additional delay may be incurred by the synchronization to the elementary stream that carries the requested service. This delay may be variable and is bounded by the time cycle of the requested service. Finally, upon synchronization to the elementary stream, decoding and presentation of the audio/visual stream may only start from a random access point and after the required buffering period has elapsed. In video streams encoded using the H.264/AVC standard, a random access point may either be an IDR (Instantaneous Decoder Refresh) picture or an INTRA picture that is marked as a random access point, which guarantees that succeeding pictures do not refer to pictures prior to the random access picture. Intelligent multiplexing may guarantee that each data burst of an elementary stream contains (or even starts with) a random access point, so that no additional delay is necessary to start decoding and displaying the video stream. Audio and subtitling streams have a much higher frequency of random access points than video streams so that they do not pose a further burden.

In an aspect of the invention, cycle duration of an elementary stream is determined to be the main factor in the total delay observed during channel switching. This delay is caused by the time slicing and presents a trade off between power efficiency and channel switch time. Decreasing the time cycle of an elementary stream will drastically increase the power consumption of the device, but will reduce the channel switch time. On the other hand, if the cycle time is increased, the power efficiency will increase at the cost of longer channel switch time. As previously mentioned, channel switching time is one of the most important quality of service parameters and assuring a low channel switch time is crucial for the service acceptance by end users.

In an aspect of the invention, a system may be provided in which an end user may receive a variety of programs or services. For example, a mobile terminal may switch between programs or services without a lengthy period between channel switching. The programs or services may be delivered to an endpoint or port in a network such as a mobile terminal according to an identified IP address and/or port number that may refer to specific ports in a network. Therefore, when a program or service is transmitted over a transmission channel, the program or service is transmitted over the channel based on the PID and may be delivered to ports according to the IP address and/or port number of a mobile terminal.

In an aspect of the invention, a user's zapping (channel switching) behavior is predicted and data reception and caching may be utilized to reduce channel switching time for programs or services delivered in a transport stream. The cached content may be used to reduce the delay when the user is switching to a new channel. For example, a transport stream may typically carry approximately 15 normal quality services (Class B media streams at a total service bitrate of around 400-500 kbps). The user may change channels available over the current transport stream (i.e. channels being carried in the same multiplex). This is typically the case as the multiplex usually carries channels of the same provider and for which the user probably already has a subscription.

Depending on the user interface of the terminal used for the mobile TV reception, channel switching may be initiated in different ways by the user. For each of the various initiated channel switching procedures, aspects of the invention are described.

In an aspect of the invention for each of the various channel switching procedures, a background download mechanism may be defined to accomplish the channel switching procedure with a minimal amount of channel switching time. For example, a mobile terminal may perform a background download of data services or programs that the user may switch to upon indication that the user is starting a channel switching procedure.

The background download may consist of downloading enough data of a specific service (or services) in anticipation of the user action to switch to that service or program. The background download implementation depends on the background download procedures which are described below.

In an aspect of the invention, the user may use the “Up” and/or “Down” (or “Next” and “Previous”) buttons on the user interface to initiate a channel switching procedure. Pressing the “Up” button will switch to the channel with next higher index or to the first channel when the current channel is the last one. Pressing the “Down” button will switch to the channel with next lower index or to the last channel when the current channel is the first one. The “Up” and/or “Down” buttons allow the user to navigate to adjacent channels in an ordered list of channels.

As it is unknown when the user may activate a channel switching procedure using the “Up” or “Down” buttons, a trigger may not be specified. However, the terminal based on the current selected channel may initiate a download of services or programs of neighboring channels as those may be the ones selected by a user using the “Up” and “Down” buttons. The background download procedure may be supported by the network or network transport. The network support may be provided by submitting parts of data of the neighboring channels, e.g. the most recent IDR frame, along with the elementary stream of the middle channel. If no network support is provided, the terminal may turn its receiver “on” during the data bursts of the neighboring channels and receive and store parts of the data for each of the transmitted services. The implementation of the background download for the “Up” and/or “Down” buttons navigation case may be performed by storing a subset of the data of the neighbor channels, e.g. the last IDR picture for each of the previous and subsequent channel. For example, if the current viewing channel is “Channel 5,” then the terminal may initiate a download of parts of the programs from neighboring channels “Channel 6” and “Channel 4.”

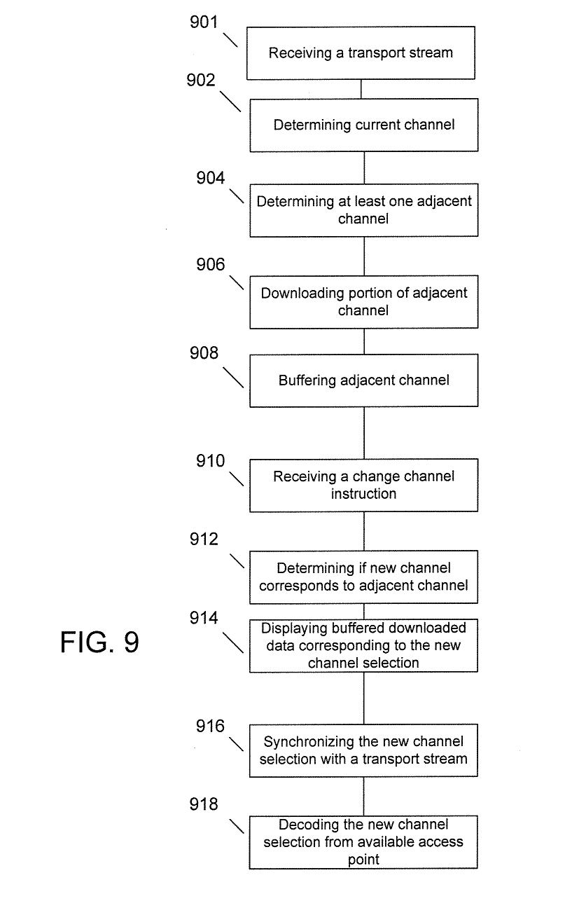

FIG. 9 illustrates a flow diagram using a service or channel switching procedure in accordance with an aspect of the invention. In FIG. 9, a terminal may receive a transport stream in step 901. Next, in step 902 a determination may be made as to the channel currently selected from an order list of channels received in the transport stream. In step 904, a determination of adjacent channels in relation to the currently selected channel may be implemented. A portion of the determined adjacent channel or channels may be downloaded (906) and buffered (908) in the terminal. In step 910, a change channel instruction may be received. Based on the received change channel instruction 910, a new channel selection may be determined in step 912. In step 914, if the new channel selection corresponds to the adjacent channel, then the buffered portion of the corresponding adjacent channel may be displayed.

Finally, in step 916, the terminal may synchronize the new channel selection with the transport stream and decode the new channel selection from an available random access point in step 918.

In an aspect of the invention, the network provider may index the channels in the order it finds suitable which maybe a default order. If the channel list has been customized by the user or the channels are not within the same transport stream, then the terminal may have to wait for the reception of the INT table to start reception of the new channel.

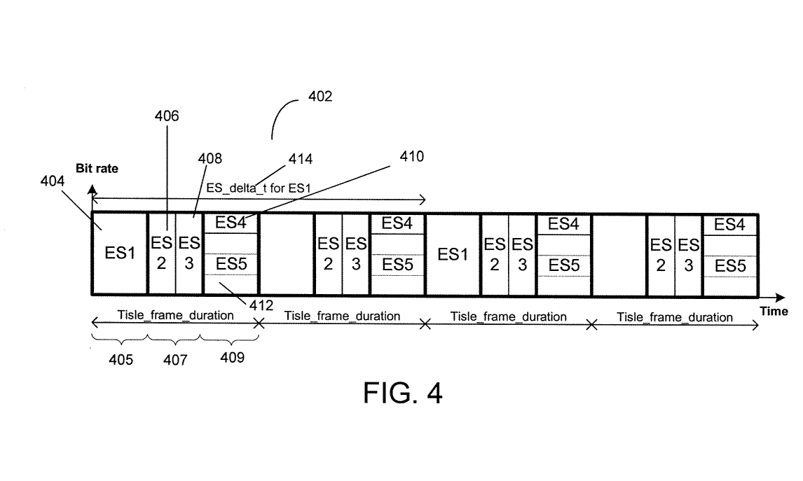

An example of a transport stream 402 carrying five “channels” (elementary streams) 404-412 is illustrated in FIG. 4. As shown in FIG. 4, the In FIG. 4, “Channel 1” corresponds to elementary stream ES1 404 and occupies one time slot 405 of the time slice frame. “Channel 2” 406 and “Channel 3” 408 share one slot 407. In addition, “Channel 4” 410 and “Channel 5” 412 also share one time slot 409.

The delta-t for elementary stream ES1 414 is different from the delta-t of other elementary streams. Those skilled in the art will realize that delta-t may not be equal for all streams. Delta-t is carried as part of the MPE section header within the MAC address fields. The PSI/SI tables may tell the receiver how to map IP multicast destination addresses to the elementary stream. Once the terminal has this mapping it my have to receive at least one MPE section per data burst to be able to locate the next data burst.

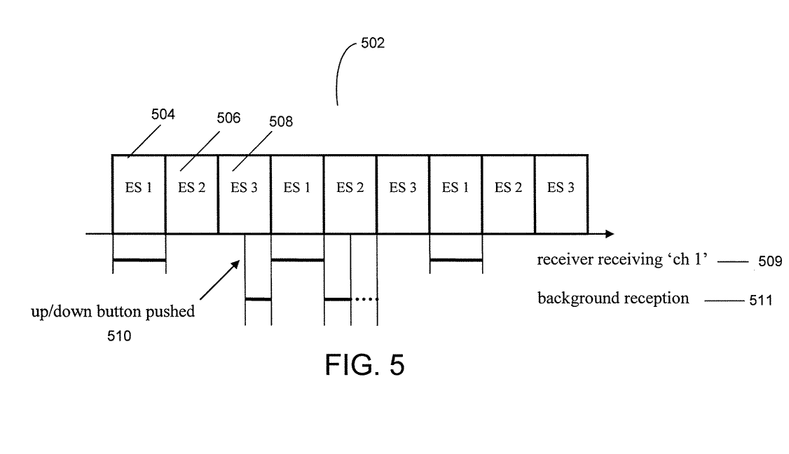

FIG. 5 illustrates an exemplary procedure for reducing channel switching time during a channel switch procedure using user interface navigation buttons for navigating an ordered list in accordance with at least one aspect of the invention. As shown in FIG. 5 a transport stream 502 includes channels or services such as channel “ES 1” 504, “ES 2” 506, and “ES 3” 508 occupies a whole time slot. As shown in FIG. 5, the receiver of a terminal may be receiving channel 1 (ES 1) 509. In FIG. 5, the receiver may be turned “on” prior to the beginning of that slot and turned “off” after the end of that slot. As those skilled in the art will realize, the terminal knows when the data burst of the neighbor channels is broadcast and may switch “on” its receiver at that time. The terminal may switch its receiver “off” after receiving enough data of the respective channel (which may e.g. be an IDR picture). When the “Up” and/or “Down” buttons are activated to select a new channel, the neighbor channels may change and the background download may be adjusted accordingly. As illustrated in FIG. 5, when the “Up” and/or “Down” buttons are activated 510, the terminal begins to buffer data in the background 511 from adjacent channels “ES 2” 506 and “ES 3” 508.

In another aspect of the invention, the terminal may receive a whole burst and the terminal picks and decodes a certain portion of the data such as the first IDR picture in that burst. As those skilled in the art will realize, the storage of entire full data bursts may not be optimal in terms of the memory storage. In an optimized memory embodiment, the implementation may try to reduce the amount of memory necessary for the storage of background data. This may be realized by detecting the last random access point, which may be the last IDR picture in an H.264/AVC video stream and pruning the data of the synchronized media of that service for which the presentation time is before that of the random access point. Furthermore, random access points may be aligned with the start of data burst times, so that the background download implementation may only need to store the beginning of a data burst.

Though the whole burst may be received in various embodiments only parts of the received data may be stored or buffered. In case of audio streams (e.g. a radio channel), the part of data should be the last audio frames in the burst.

In another aspect of the invention, an electronic service guide may be displayed as an overlay to the user interface screen or as a part of the user interface screen based a user request. The user may request to view the electronic service guide by activating a button on the terminal. The electronic service guide displays a list of available services and channels. The user may use the navigation buttons on the terminal to navigate to the channel or service of interest. In an embodiment, upon activation of an OK button (or possibly upon highlighting the selected channel) the selected channel or service is executed.

In an aspect of the invention, upon activation of the electronic service guide, a background download procedure may be implemented in which all data of a transport stream may be received and buffered. The receiver may even be turned “on” for the whole duration of the channel selection, which typically may last a couple of seconds. As those skilled in the art will realize, power consumption may be increased during this procedure. In addition, some implications on memory requirements may be realized as receiving and processing an MPE frame will usually require some time so that reception of consecutive MPE frames will require additional memory. In an embodiment, MPE-FEC decoding may be turned “off” to reduce processing time. In an additional embodiment, the background download procedure may be implemented by switching “off” time slicing during this period.

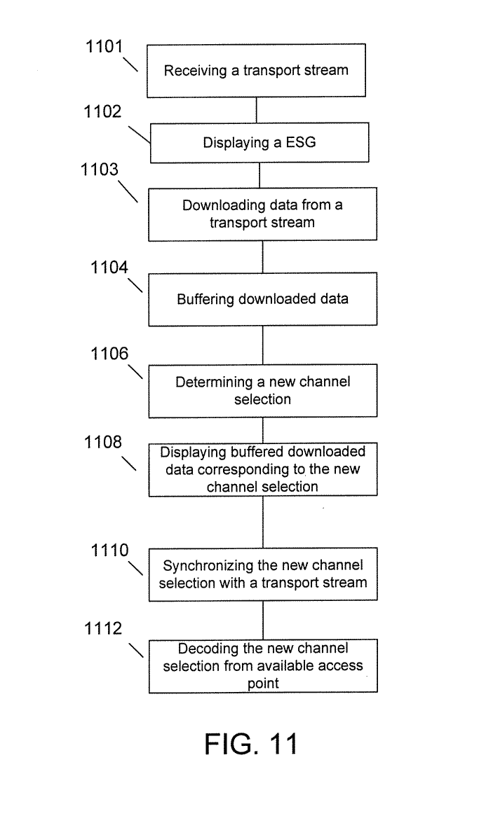

FIG. 11 illustrates a flow diagram showing a service or channel switching procedure in accordance with at least one aspect of the invention. In FIG. 11, a transport stream may be received in step 1101. In step 1102, an electronic service guide may be displayed. The electronic service guide may detail a list of available services and channels to the user.

Next, in step 1103 a terminal may download data from the transport stream included in the electronic service guide list of available services and channels. In step 1104, the downloaded data may be buffered. A determination of a new channel selection may be made in step 1106. In step 1108, the buffered downloaded data corresponding to the new channel selection may be displayed. Finally, the terminal may synchronize the new channel selection with the transport stream in step 1110 and decode the new channel selection from an available random access point in step 1112.

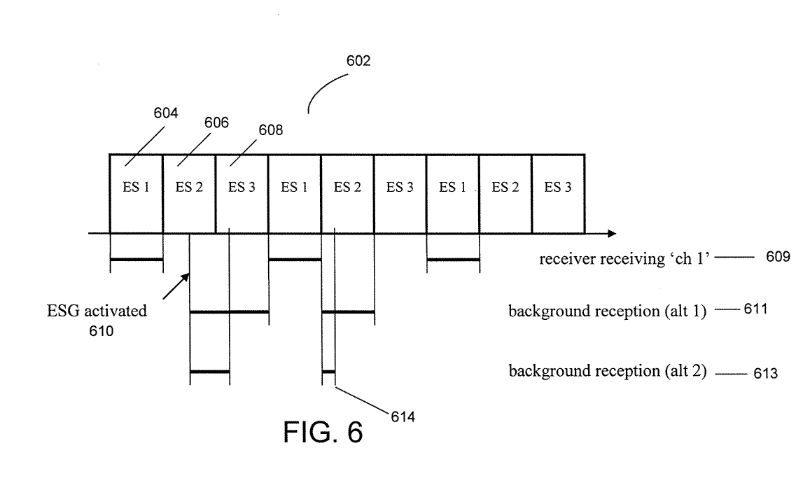

FIG. 6 illustrates an exemplary procedure for reducing channel switching time during a channel switch procedure using an electronic service guide in accordance with at least one aspect of the invention. As shown in FIG. 6, a transport stream 602 may include channels or services such as channel “ES 1” 604, “ES 2” 606, and “ES 3” 608. Each of channels “ES 1” 604, “ES 2” 606, and “ES 3” 608 may occupy an entire time slot. As shown in FIG. 6, the terminal may be receiving channel 1 (ES 1) 609.

In FIG. 6, the receiver may be turned “on” and may receive and buffer all channels or services until the user selects a channel displayed by the electronic service guide. For example in FIG. 6, background reception (alt 1) 611 illustrates the receipt and buffering of all channels based activation of the electronic service guide.

In another embodiment, the receiver may be turned “on” for only short time at the beginning of every burst so that a portion of each channel is received and buffered. As those skilled in the art will realize, the terminal knows when the data burst of the channels is broadcast and may switch “on” its receiver at that time. The terminal may switch its receiver “off” after receiving enough data of the respective channel (which may e.g. be an IDR picture). For example in FIG. 6, background reception (alt 2) 613 illustrates the receipt and buffering of only a portion of “ES 2” 614 as enough current information of “ES 2” has been buffered for potential use.

In another aspect of the invention, the user may utilize a keypad to switch channels or services. For example, the user may switch channels or services by entering a channel or service code on the terminal. A keypad press indicating the first number in a channel index may provide a trigger to begin a background download. The implementation of the background download for the keypad button may depend on the time available for the background download. In an embodiment where the time available for download is short (a few seconds), the receiver may be turned “on” and may receive and buffer all channels or services.

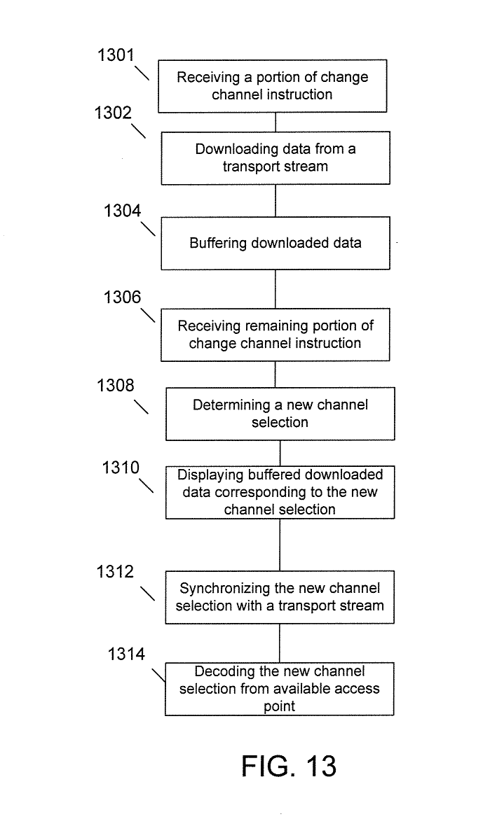

FIG. 13 illustrates the use of a key pad or other input device to reduce channel switching time for services or channels in accordance with an aspect of the invention. In FIG. 13, a portion of channel instruction may be received in step 1301. Next, in step 1302 data may be downloaded from a transport stream. In step 1304, the downloaded data may be buffered. The remaining portion of the change channel instruction may be received in step 1306. In step 1308, a new channel selection may be determined based on the completed change channel instructions. The buffered downloaded data corresponding to the new channel selection may be displayed in step 1310. Finally, the new channel selection may be synchronized with the transport stream in step 1312 and decoded from an available random access point in step 1314.

In an alterative embodiment where the time available for download is greater than a couple of seconds, any received input (such as numerical key entry) may be used to filter channels in the transport stream to determine the potential new channel being selected. Portions of the determined potential new channels may be downloaded and buffered for use during synchronization and decoding of the new channel during channel switching.

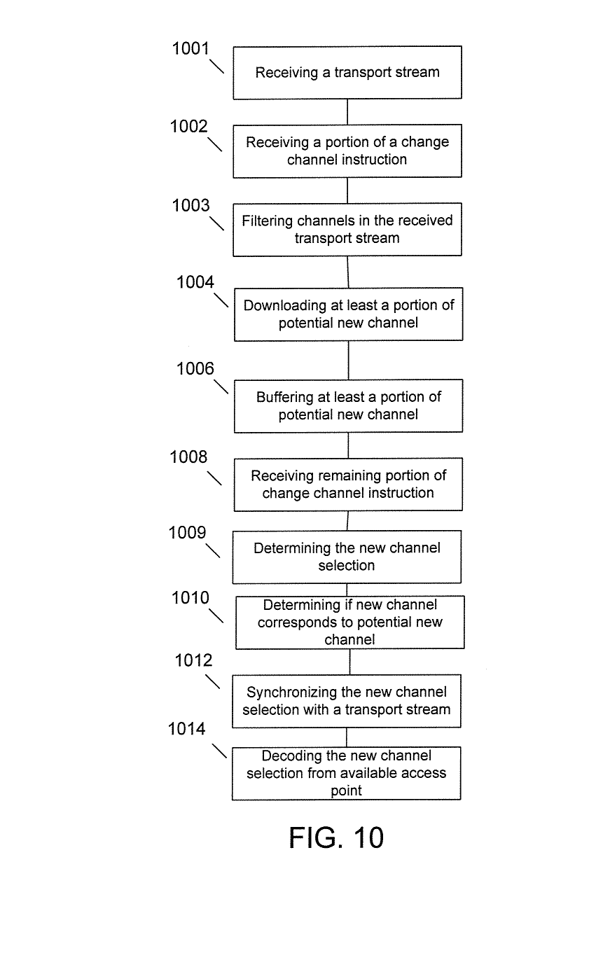

FIG. 10 illustrates a flow diagram using an alternative service or channel switching procedure in accordance with at least one aspect of the invention. In FIG. 10, a transport stream may be received in step 1001. Next, in step 1002 a portion of a channel instruction may be received in step 1002. Next, in step 1003 based on the received portion of change channel instruction, filtering of the channels may be initiated. The filtering may be used to determine potential new channels that may be selected by the user. Next, in step 1004, a portion of the data related to the determined potential new channels may be downloaded. In step 1006, the downloaded data may be buffered. The remaining portion of the change channel instruction may be received in step 1008.

In step 1009, the new channel selection may be determined based on the entire change channel instructions. In step 1010, if the new channel selection corresponds to the potential new channel, then the buffered portion of the corresponding new channel may be displayed. Finally, the new channel selection may be synchronized with the transport stream in step 1012 and decoded from an available random access point in step 1014.

In another aspect of the invention, the user may be notified about the start of a given schedule event, by displaying an overlay screen with a notification message. The notification message may contain a link to a channel of interest. The notification may be originated by the terminal itself or by the network. In an embodiment, the terminal may manage the service subscription for the user and inform the user about forthcoming schedule events for which the user has a subscription. In another embodiment, network notifications may carry advertisement for a given service or schedule event and a link to that specific service location.

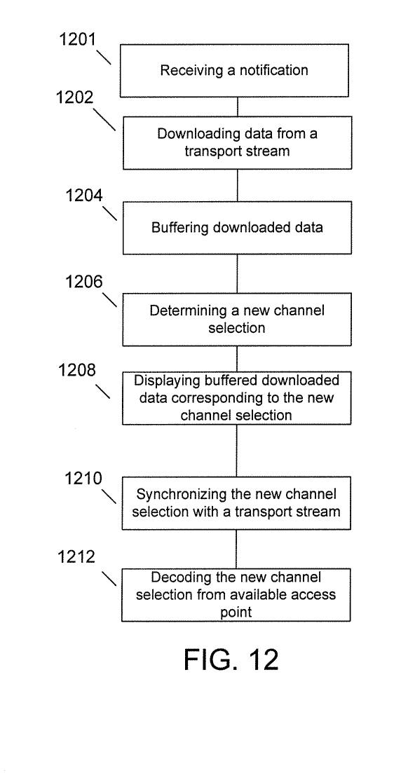

FIG. 12 illustrates an additional flow diagram showing a service or channel switching procedure in accordance with at least one aspect of the invention. In FIG. 12, a notification concerning a service or channel may be received in step 1201. In step 1202, data may be downloaded from a transport stream based on the received notification. In step 1204, the downloaded data may be buffered. A determination of a new channel selection may be made in step 1206. In step 1208, the buffered downloaded data corresponding to the new channel selection may be displayed. Finally, in step 1210 the new channel selection may be synchronized with the transport stream and decoded from an available random access point in step 1212.

As the notification screen displays the new targeted channel to be selected by the user, the terminal may request implementation of the background download of a portion of the targeted channel. The downloaded portion of the targeted channel may be stored and/or buffered for later access should the targeted channel be requested by the user.

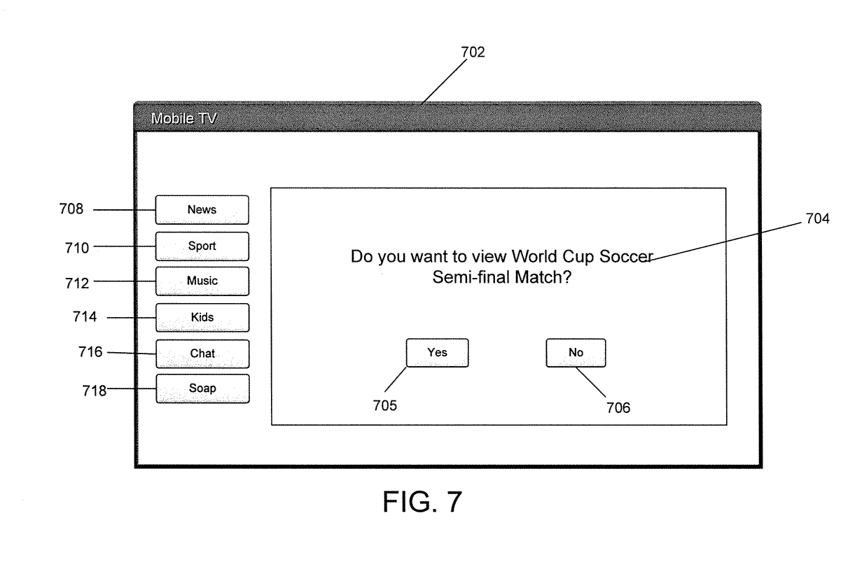

FIG. 7 illustrates an additional exemplary procedure for reducing channel switching time during a channel switch procedure including a user interface for notifying a user about a service or scheduled event in accordance with at least one aspect of the invention. In FIG. 7, a user interface screen 702 may be displayed which queries the user “Do you want to view World Cup Soccer Semi-final Match?” 704. The user may respond by selecting the “Yes” selection box 705 or the “No” selection box 706. If the user chooses the “Yes” selection box 705, a channel change may be initiated. As the targeted channel, a Sports channel, was known prior to the user selection based on the received notification, the terminal already contains a buffered portion of the Sports channel for display to the user during the channel switching. The downloaded portion of the Sports channel may be displayed during synchronization of the new channel selection with the transport stream and decoding the new channel selection.

In another aspect of the invention, user interface screen 702 may also be provided to a user at various times to act as a menu for the various channels. For instance, news-related services may be provided by executing the news button 708. Similar service or channel specific buttons may also be provided for other types of services or channels such as sports 710, music 712, kids-related services 714, chat 716 and soap services 718.

In an embodiment of the invention, the notification message may be sent over a cellular network and/or a broadcast network. In addition, if the terminal has subscribed to a notification service, the terminal may also be capable of initiating a notification message. Moreover, in another embodiment, the notification may be generated by the terminal combining the data in the ESG with the subscription file. Furthermore, in an additional embodiment, the notifications may be synchronized to the start of the scheduled event so that by responding to the notification, the receiver may be switched instantly to the channel transmitting the scheduled event. Any momentary delay may not be detected by the user as the background download would have been implemented upon receipt of the notification.

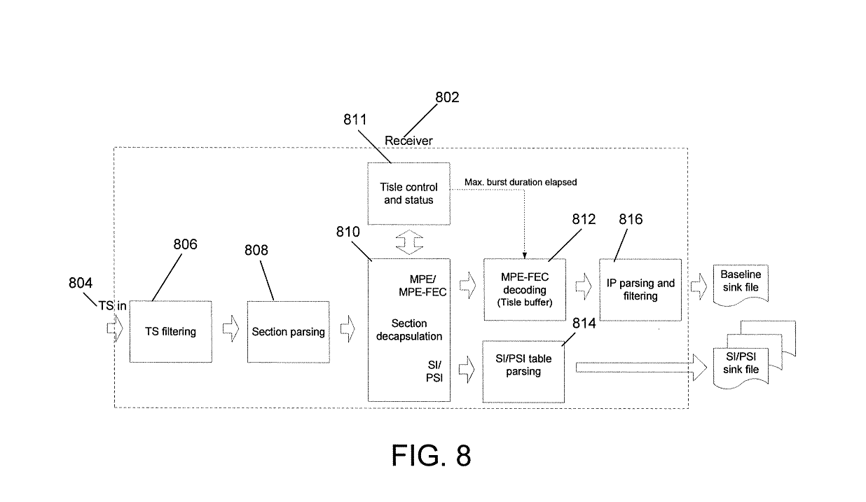

FIG. 8 illustrates a partial block diagram showing an exemplary receiver 802 in accordance with at least one aspect of the invention. The receiver 802 may be part of the DVB-H receiver 141 of FIG. 2. The output of the receiver 802 may consist of IP streams which are forwarded for storing and/or processing and rendering.

As shown in FIG. 8, a transport stream 804 may be routed to a transport stream filter 806. The transport stream filter 804 may receive the entire transport stream 804 and filter the stream based on PID values obtained from a PMT table. The transport stream filter 804 may only allow through transport stream packets belonging to desired elementary streams. In an embodiment of the invention, an option may be provided to either discard or allow through erroneous packets.

Next, a section parsing block 808 decapsulates the payload of the transport stream packets and forms sections from these payloads. The section parsing block 808 may also take into account a possible adaptation field and payload unit start indicator (PUSI).

The sections from the section parsing block 808 are routed to a section decapsulation block 810 which extracts the real time parameters and the payload of the section. According to the table_id, the decapulation block 810 separates the payload along with some real time parameters into the MPE/MPE-FEC decoding block 812 or SI/PSI output.

Real time parameters may be sent to the time slicing control and status block 811. The time slicing control and status block 811 may analyze the real time parameters and generate different status data as a result. The time slicing control and status block 811 may also signal the MPE-FEC decoding block 812 when the maximum burst duration is elapsed. This signaling may be needed to start the decoding if the end of the burst is lost. The MPE-FEC decoding block 812 may write the section payloads into the MPE-FEC frame according to the address information (real time parameter) and decode the whole frame row by row. Erasure and non-erasure decoders may be implemented. The erasure info may be obtained from the section CRC-32 or, if the erroneous transport stream packets are passed forward, from the transport error indicator located in the header of the TS packet. If the MPE-FEC decoding block 812 is not used, then this block may only work as a time slicing buffer by storing one burst at a time.

The IP parsing and filtering block 816 receives the whole MPE-FEC frame. The IP parsing and filtering block 816 may go through the corrected data areas in the frame to detect IP datagrams that were originally erroneous but were corrected by the decoder. Next, the IP parsing and filtering block 816 passes through only the IP datagrams with the desired IP address. The filter parameters may be taken from an NT table which declares all IP streams of a transport stream. Although FIG. 8 shows that the SI/PSI data is not provided with MPE-FEC encoding, it may be delivered in a similar way than the IP datagrams carrying application data.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method comprising:
receiving a transport stream;
determining a currently selected channel from an ordered list of channels in the received transport stream;
determining at least one adjacent channel based on the currently selected channel;
downloading at least a portion of a data burst of the at least one adjacent channel;
buffering at least the portion of said data burst of the at least one adjacent channel;
receiving a change channel instruction;
determining a new channel selection based on the change channel instruction;
determining if the new channel selection corresponds to the at least one adjacent channel, and if the new channel selection corresponds to the at least one adjacent channel, displaying the buffered portion of said data burst of the corresponding at least one adjacent channel;
synchronizing the new channel selection with the transport stream; and
decoding the new channel selection from an available random access point.

2. The method of claim 1, wherein the random access point comprises an instantaneous decoding refresh (IDR) picture.

3. The method of claim 1, wherein the random access point comprises an INTRA picture.

4. The method of claim 1, wherein the received change channel instruction is executed by navigation buttons located on a mobile terminal.

5. The method of claim 4, wherein the navigation buttons comprise “Up” and “Down” buttons.

6. A method comprising:
receiving a transport stream from a network;
receiving a portion of a change channel instruction;
based on the received portion of the change channel instruction, filtering channels in the received transport stream to determine potential new channels;
downloading at least a portion of a data burst of the determined potential new channels;
buffering at least the portion of said data burst of the potential new channels;
receiving a remaining portion of the change channel instruction;
determining a new channel selection based on entire change channel instruction;
determining if the new channel selection corresponds to the potential new channels, and if the new channel selection corresponds to the potential new channels, displaying the buffered portion of said data burst of the corresponding potential new channel;
synchronizing the new channel selection with the transport stream; and
decoding the new channel selection from an available random access point.

7. The method of claim 6, wherein the random access point comprises an instantaneous decoding refresh (IDR) picture.

8. The method of claim 6, wherein the random access point comprises an INTRA picture.

9. The method of claim 6, wherein the received change channel instruction is executed by numerical buttons.

10. The method of claim 6, wherein the channels included in the transport stream comprise an ordered list.

11. The method of claim 6, wherein the network comprises a DVB-H network.

12. The method of claim 6, wherein the transport stream comprises an IP stream.

13. A method comprising:
receiving a transport stream from a network;
displaying an electronic service guide, the electronic service guide displaying a list of available services and channels;
downloading data from the transport stream included in the electronic service guide list of available services and channels;
buffering the downloaded data;
determining a new channel selection;
displaying the buffered downloaded data corresponding to the new channel selection;
synchronizing the new channel selection with the transport stream; and
decoding the new channel selection from an available random access point.

14. The method of claim 13, wherein the random access point comprises an instantaneous decoding refresh (IDR) picture.

15. The method of claim 13, wherein the random access point comprises an INTRA picture.

16. The method of claim 13, wherein the step of downloading data from the transport stream is triggered by the displaying of the electronic service guide.

17. The method of claim 13, wherein the network comprises a DVB-H network.

18. The method of claim 13, wherein the transport stream comprises an IP stream.

19. A method comprising:
receiving a notification concerning a service or channel;
downloading data from a transport stream based on the received notification;
buffering the downloaded data;
determining a new channel selection;
displaying the buffered downloaded data corresponding to the new channel selection;
synchronizing the new channel selection with the transport stream; and
decoding the new channel selection from an available random access point.

20. The method of claim 19, wherein the random access point comprises an instantaneous decoding refresh (IDR) picture.

21. The method of claim 19, wherein the random access point comprises an INTRA picture.

22. The method of claim 19, wherein the notification is included in all channels and services included in the transport stream.

23. The method of claim 19, wherein the notification is synchronized to a start of a scheduled service or channel.

24. A method comprising:
receiving a transport stream from a network;
receiving a portion of a change channel instruction;
downloading data from a transport stream;
buffering the downloaded data;
receiving remaining portion of the change channel instruction;
determining a new channel selection based on entire change channel instruction;
displaying the buffered downloaded data corresponding to the new channel selection;
synchronizing the new channel selection with the transport stream; and
decoding the new channel selection from an available random access point.

25. The method of claim 24, wherein the random access point comprises an instantaneous decoding refresh (IDR) picture.

26. The method of claim 24, wherein the random access point comprises an INTRA picture.

27. The method of claim 24, wherein the received change channel instruction is executed by numerical buttons.

28. The method of claim 24, wherein the channels included in the transport stream comprise an ordered list.

29. The method of claim 24, wherein the network comprises a DVB-H network.

30. The method of claim 24, wherein the transport stream comprises an IP stream.

31. An apparatus comprising:
a communication interface;
a receiver;
a transmitter;
a storage medium; and
a processor coupled to the storage medium and programmed with computer-executable instructions to perform the steps comprising:
means for determining a currently selected channel from an ordered list of channels in a transport stream;
means for determining at least one adjacent channel based on the currently selected channel;
means for downloading at least a portion of a data burst of the at least one adjacent channel;
means for buffering at least the portion of said data burst of the at least one adjacent channel;
means for receiving a change channel instruction; means for determining a new channel selection based on the change channel instruction;
means for determining if the new channel selection corresponds to the at least one adjacent channel, and
if the new channel selection corresponds to the at least one adjacent channel, displaying the buffered portion of said data burst of the corresponding at least one adjacent channel;
means for synchronizing the new channel selection with the transport stream; and
means for decoding the new channel selection from an available random access point.
